(19) United States
(12) Patent Application Publication
(10) Pub. No.: US 2010/0163583 A1
(43) Pub. Date: Jul. 1, 2010

(54) Holder for Containing and Dispensing a Fluid

(75) Inventor: Jacob Gerrit Niemans, Zierikzee (NL)

Correspondence Address: BOZICEVIC, FIELD & FRANCIS LLP, 1900 UNIVERSITY AVENUE, SUITE 200, EAST PALO ALTO, CA, 94303, US

(73) Assignee: Bema Kunsttoffen B.V., RC Zierlkzee (NL)

(21) Appl. No.: 12/598,188

(22) PCT Filed: May 7, 2008
(86) PCT No.: PCT/NL2008/000125

§ 371 Date: Feb. 12, 2010

(30) Foreign Application Priority Data
May 7, 2007 (NL) 2000634

(51) Int. Cl. B67D 7/60

(52) U.S. Cl. 222/386

(57) ABSTRACT

Container (1) for storing a liquid, particularly concentrated liquid colour pigment for paint, which container is provided with a closable opening and which container comprises a tubular wall (2), a lid (3) and a bottom (4) axially movable in the tube, which bottom is substantially formed by a disc, such that liquid present in the container can be pressed out of the container via the opened opening by moving the bottom toward the lid.

The present invention relates to a container for storing a liquid, which container is provided with a closable opening and which container comprises a tubular wall, a lid and a bottom.

Such containers are generally known, for instance in the form of a paint can. The invention relates particularly to containers for storing concentrated liquid colour pigment for paint, this pigment being used to give a base paint a desired colour. This concentrated liquid colour pigment is relatively expensive. A problem with existing containers is that part of the expensive pigment (about 3-8%) remains in the container when it is poured due to adhesion to the wall, the lid and the bottom. This remaining pigment can be scraped out of the container using a spatula, although this is perceived to be laborious and is therefore often dispensed with.

The invention has for its object a container which solves this problem in an easy, reliable and inexpensive manner.

For this purpose the bottom is substantially formed by a disc, and the bottom is axially movable in the tube such that liquid present in the container can be pressed out of the container via the opened opening by moving the bottom toward the lid. In this way practically all the liquid can be pressed out of the container. The disc preferably has a thickness here such that it can move as a piston in the tube without tilting as it does so. As shown in the described preferred embodiment, the term disc must otherwise also be understood to mean a hollow disc, in particular a substantially tubular (in particular frusto-conical) side wall with a plate-like upper wall on the side directed toward the lid of the container.

In the preferred embodiment at least the side of the disc directed toward the lid has an outer diameter in radial direction which is smaller than the inner diameter of the tube, wherein the side of the bottom directed toward the lid is provided along the peripheral edge with a scraping element extending laterally from the peripheral edge of the disc to the wall of the tube. Since not the whole peripheral surface is in contact with the wall of the container, this surface is easily movable in the tubular wall with little friction. The scraping element is preferably manufactured integrally with the disc, whereby the bottom is simple to manufacture and to reuse.

The normal to the scraping surface is preferably oriented obliquely to the lid and the axis of the tube, whereby the liquid is guided away from the wall and the liquid can less easily enter between the bottom and the wall. The scraping element is preferably strip-like and preferably has a sharp edge on its outer end. In this way an effective scraping effect is obtained, while there is minimal contact between the wall and the bottom, so there is minimal friction. It is noted here that, if the lid is arranged on or in the opening after the liquid has been arranged in the container, the interior of the container usually comes under a pressure. This pressure can be readily absorbed by the inclination of the scraping surface.

The side of the lid directed toward the bottom is preferably provided with a recess in which the scraping element can be received such that the surfaces of the bottom and the lid can rest at least substantially fully against each other. At least substantially all liquid can hereby be pressed out of the container.

The bottom is preferably provided with a second scraping element extending from the peripheral edge of the disc at a distance from the first scraping element for the purpose of collecting liquid which has possibly leaked along the first scraping element. The second scraping element preferably has substantially the same form as the first scraping element and extends in the same direction.

The peripheral edge of the disc is preferably also substantially frusto-conical, wherein the outer diameter of the disc on the side remote from the lid is equal to the inner diameter of the tube. In this way the bottom only has contact with the wall at several annular locations, so that there is little friction and a good seal.

The orientation of the frusto-conical form of the peripheral edge can be opposite to that of the scraping surface, particularly in an embodiment with a smaller peripheral form of the disc than the inner form of the container and with a scraping element extending obliquely outward (also referred to below in terms of the position of the normal to the scraping surface). The frusto-conical form of or on the peripheral edge will also be referred to below as side wall on the bottom or disc. The frusto-conical protrusion on the peripheral edge of the disc and the scraping surface oriented in opposite direction thereto can thus together form a stabilizer which, when the bottom is displaced, can ensure an orientation thereof transversely of the axial direction of the container without having to utilize a particularly thick disc for this purpose, while at the same time an effective scraping surface is provided. In an embodiment with a frusto-conical form instead of a purely cylindrical form, and with the scraping surface oriented in opposite direction, the contact surface between the bottom or disc (and the elements connected thereto) on the one hand and the container on the other will here be minimal. As a result it will also be possible for the frictional forces holding back the movement to remain minimal.

The bottom is preferably provided with external engaging means in order to move the bottom in the tube. These are preferably situated on the axis of the tube so that the bottom is not pushed askew during use.

The closable opening is preferably provided in the lid. The closable opening is preferably also situated on the axis of the tube. The lid is preferably provided with strengthening ribs for preventing bulging of the lid when pressure is exerted.

The closable opening is preferably sealed, for instance with tearable foil. The closable opening is preferably provided here with a removable cap. The lid is preferably integrally removable from the tube in reclosable manner. The container can hereby be reused in simple manner by being cleaned and refilled.

The container is preferably manufactured from plastic. The tube is preferably a cylinder.

The disc of the bottom preferably comprises a plate-like upper wall on the side directed toward the lid of the container, wherein a substantially tubular side wall extends from the peripheral edge of the upper wall in the direction away from the lid. This side wall may diverge slightly in said orientation so as to provide the above stated frusto-conical form. The tubular side wall of the container is preferably provided here on the underside thereof with inward folded edge in which the side wall of the bottom extending in this direction can be received. In this way a connection with more or less clamping fit can be achieved between the bottom and the container, thereby preventing leakage of the liquid.

The invention also relates to a system comprising a container as described here and a preferably detachable outlet pipe, such as a pouring pipe through which paint can be discharged from the container, which outlet pipe is provided with mounting means with which the outlet pipe can be mounted in the opening of the container. In this manner the liquid can be poured or otherwise discharged from the container without spillage. The mounting means preferably comprise releasable snap connecting means.

The outlet pipe is preferably provided with a pointed outer end with which the seal of the opening can be pierced. The bottom of the container is preferably provided with a cavity for receiving the pointed end of the outlet pipe so that it does not impede complete emptying of the container. The cavity is preferably formed in the above stated external engaging means of the bottom.

The invention will be further illustrated on the basis of an exemplary embodiment shown in the figures, in which:

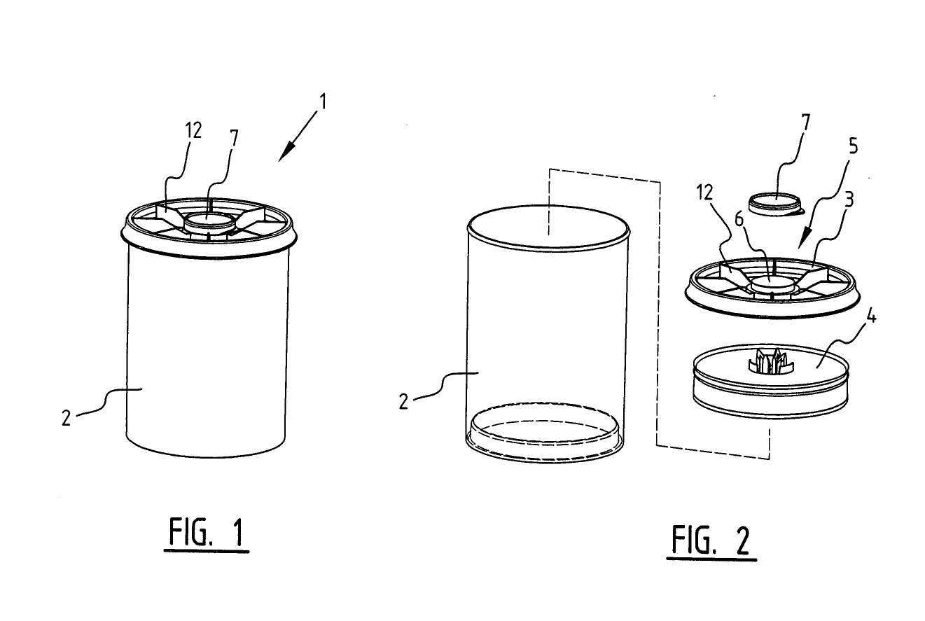

FIG. 1 shows a perspective view of a container according to the invention;

FIG. 2 shows an exploded view of the container of FIG. 1;

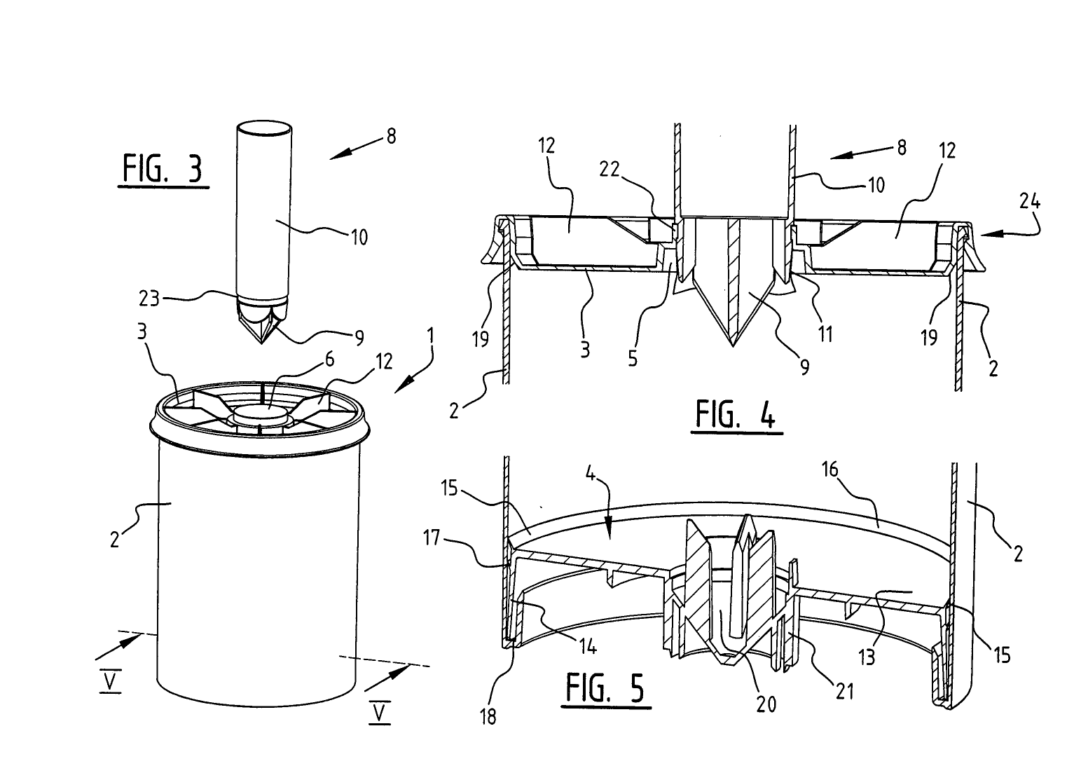

FIG. 3 shows a system with a container and an outlet pipe according to the invention;

FIG. 4 shows a cross-section of a detail of the system of FIG. 3;

FIG. 5 shows a perspective cross-section of a detail of the container of the system of FIG. 3;

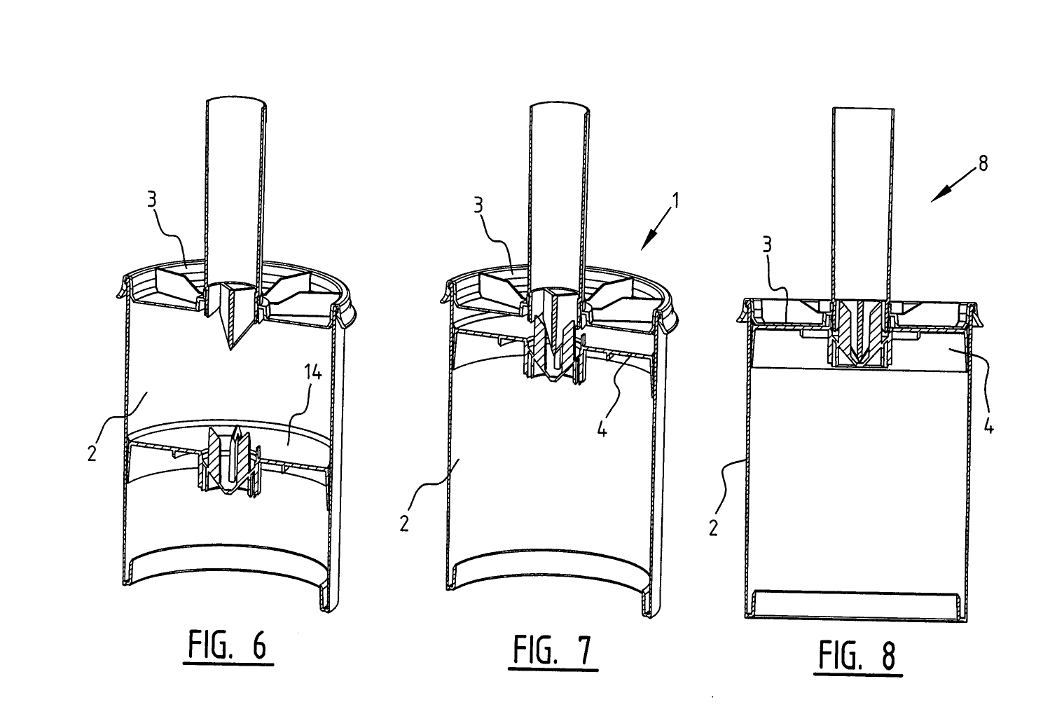

FIGS. 6 and 7 show a perspective cross-section of the system of FIG. 3; and

FIG. 8 shows a cross-section of the system of FIG. 3.

According to FIGS. 1 and 2, a container 1 manufactured wholly of plastic for storing and pouring liquid colour pigment for paint comprises a cylindrical wall 2, a lid 3 and a substantially disc-shaped bottom 4 which is slidable in cylindrical wall 2. Lid 3 has a central pouring opening 5 which is provided with an aluminium foil seal 6 and which is further closed by a reclosable cap 7. Lid 3 with cap 7 can also be removed wholly from cylindrical wall 2 and reclosed so that container 1 can easily be cleaned and reused.

Lid 3 is provided on the external side with radially extending strengthening ribs 12 in order to prevent bulging of lid 3 when pressure is exerted.

According to FIG. 3 a system for storing and pouring liquid colour pigment for paint comprises a container 1 as described in the previous paragraph and a pouring spout 8. This pouring spout is provided with a pointed outer end 9 with which the aluminium foil seal 6 can be pierced. Pointed end 9 consists of three walls which are placed in a star shape and is arranged in the opening on an outer end of a pipe 10.

According to FIG. 4, the outer end of pouring spout 8 is provided on the side of pointed end 9 with an external annular recess in which an annular internal edge 22 of pouring opening 5 can be received. Pouring spout 8 is further provided with outer wall 11 tapering toward the outer end. In this way the pouring spout 8 can be inserted into pouring opening 5 and snapped into place. It can also be released again by exerting some force. Lid 3 is also provided along the peripheral edge with a per se known elastic snap closure 24.

According to FIG. 5, the substantially disc-shaped movable bottom 4 comprises a circular bottom plate 13, wherein a slightly frusto-conical/cylindrical side wall 14 extends from the peripheral edge of bottom plate 13, which side wall tapers slightly towards the outer end. The diameter of bottom plate 13 is slightly smaller than the inner diameter of cylindrical wall 2, while due to the slightly frusto-conical form of side wall 14 the diameter at the bottom end thereof is equal to the inner diameter of cylindrical side wall 2. On the top side, from the circular intersecting line of bottom plate 13 and side wall 14, a substantially strip-like scraping element 15 extends in an oblique upward and outward direction. In this way scraping element 15 has an annular scraping surface 16 oriented obliquely upward in the direction of the axis of cylindrical wall 2. Scraping element 15 tapers to a point towards its outer end. The outer end of scraping element 15 has a diameter equal to the diameter of wall 2 of the container.

Situated a short distance below scraping element 15 (at about 25% of the overall height of the disc-shaped bottom) is a second scraping element 17 of the same form which extends in the same direction (upward).

The underside of cylindrical side wall 2 of the container has a form curved inward through 180 degrees to be able to accommodate the lower end of the substantially cylindrical wall 14 of bottom 4. The bottom of the U-shaped lower end of the cylinder wall obtained in this manner is provided with a small clamping edge 18 such that the outer end of the end of wall 14 of the bottom can be clamped between this clamping edge 18 and the inner side of cylindrical wall 2.

Bottom plate 13 is provided with a central conical deformation such that on the upper side a cavity 20 is formed in which the pointed end 9 of pouring spout 8 can be received when bottom 4 reaches lid 3. On the underside the cone is enclosed by a central cylindrical wall 21 which can be used by the user of the container to exert pressure when emptying the container.

On its underside the lid 3 is provided along the peripheral edge with a surface 19 which is chamfered obliquely upward and outward and which has a form corresponding to the upward and outward protruding scraping surface 16. Bottom 4 can hereby be pushed against lid 3 such that the surfaces thereof fully contact each other over at least the greater part thereof, whereby all liquid is pressed from between them, as shown in FIGS. 6-8. With the container according to this preferred embodiment only about 1% of the liquid remains in the container after emptying.

1. Container for storing a liquid, particularly concentrated liquid colour pigment for paint, which container is provided with a closable opening and which container comprises a tubular wall, a lid for selective closure of the opening, and a bottom axially movable in the tube, which bottom is substantially formed by a disc, such that liquid present in the container can be pressed out of the container via the opening in an opened position thereof by moving the bottom toward the lid.

2. Container as claimed in claim 1, wherein the disc has a thickness such that it can move as a piston in the tube without tilting as it does so.

3. Container as claimed in claim 1 or 2, wherein at least the side of the disc directed toward the lid has an outer diameter in radial direction which is smaller than the inner diameter of the tube, wherein the side of the bottom directed toward the lid is provided along the peripheral edge with a scraping element extending laterally from the peripheral edge of the disc to the wall of the tube.

4. Container as claimed in claim 3, wherein the normal to the scraping surface is oriented obliquely to the lid and the axis of the tube.

5. Container as claimed in claim 3 or 4, wherein the scraping element is strip-like and has a sharp edge on its outer end.

6. Container as claimed in claim 3, 4 or 5, wherein the side of the lid directed toward the bottom is provided with a recess in which the scraping element can be received such that the surfaces of the bottom and the lid can rest at least substantially fully against each other.

7. Container as claimed in any of the foregoing claims 3-6, wherein the bottom is provided with a second scraping element extending from the peripheral edge of the disc at a distance from the first scraping element.

8. Container as claimed in claim 7, wherein the second scraping element has substantially the same form as the first scraping element and extends in the same direction.

9. Container as claimed in any of the foregoing claims 1-8, wherein the peripheral edge of the disc is substantially frusto-conical, wherein the outer diameter of the disc on the side remote from the lid is equal to the inner diameter of the tube.

10. Container as claimed in any of the foregoing claims 1-9, wherein the bottom is provided with external engaging means in order to move the bottom in the tube.

11. Container as claimed in any of the foregoing claims 1-10, wherein the closable opening is provided in the lid.

12. Container as claimed in claim 11, wherein the closable opening is situated on the axis of the tube.

13. Container as claimed in any of the foregoing claims 1-12, wherein the closable opening is sealed, for instance with tearable foil.

14. Container as claimed in any of the foregoing claims 1-13, wherein the closable opening is provided with a removable cap.

15. Container as claimed in any of the foregoing claims 1-14, wherein the lid is integrally removable from the tube in reclosable manner.

16. Container as claimed in any of the foregoing claims 1-15, wherein the container is manufactured from plastic.

17. Container as claimed in any of the foregoing claims 3-16, wherein the scraping element is manufactured integrally with the disc.

18. Container as claimed in any of the foregoing claims 1-17, wherein the tube is a cylinder.

19. Container as claimed in any of the foregoing claims 1-18, wherein the lid is provided with strengthening ribs for preventing bulging of the lid when pressure is exerted.

20. Container as claimed in any of the foregoing claims 1-19, wherein the disc comprises a plate-like upper wall on the side directed toward the lid of the container, wherein a substantially tubular side wall extends from the peripheral edge of the upper wall in the direction away from the lid.

21. Container as claimed in claim 20, wherein the tubular side wall is provided on the underside with an edge which is folded inward through at least substantially 180 degrees and in which the side wall of the bottom extending in this direction can be received.

22. System comprising a container as claimed in any of the foregoing claims 1-21, and an outlet pipe through which paint or pigment can be discharged from the container, which outlet pipe is provided with mounting means with which the outlet pipe can be mounted in the opening of the container.

23. System as claimed in claim 22, wherein the mounting means comprise releasable snap connecting means.

24. System as claimed in claim 22 or 23, with the container as claimed in claim 13, wherein the outlet pipe is provided with a pointed outer end with which the seal of the opening can be pierced.

25. System as claimed in claim 24, wherein the bottom of the container is provided with a cavity for receiving the pointed end of the outlet pipe.

26. System as claimed in claim 25, wherein the cavity is formed in the external engaging means of the bottom.
